(19) United States
(12) Patent Application Publication
(10) Pub. No.: US 2003/0023597 A1
(43) Pub. Date: Jan. 30, 2003

(54) Methods and systems for automated project management

(76) Inventors: Pearl Ha, Schenectady, NY (US); Eileen M. Conway, Schenectady, NY (US); Bruce Thomas, Ballston Lake, NY (US)

Correspondence Address: PERKINS COIE LLP, PATENT-SEA, P.O. BOX 1247, SEATTLE, WA, 98111-1247, US

(21) Appl. No.: 09/912,248

(22) Filed: Jul. 24, 2001

(51) Int. Cl. G06F 7/00

(52) U.S. Cl. 707/10

(57) ABSTRACT

Methods and systems for initiating a project or requesting a project review. In one embodiment, a user accesses a project management display page from a project management site and selects a project initiation button or a project review button. Selecting project initiation brings forth a project information display page for receiving selected project information such as a project title, leader, category, and cost. Selecting project review brings forth a project review display page for receiving selected project review information. Selecting a send button after entering the project information automatically sends a portion of the project information to a selected recipient and a selected database.

### TECHNICAL FIELD

The following disclosure relates generally to project management and, more particularly, to computer-implemented methods for initiating a project or requesting a project review.

### BACKGROUND

To remain competitive, companies attempt to focus their resources on projects that best advance their business goals. Selection of such projects is typically accomplished in a series of loosely defined steps. For example, a particular business group within a company may decide that a particular project would support the company's business goals and, accordingly, initiates the project. Members of this group may then prepare presentation materials outlining important aspects of the proposed project, such as time schedules, resource allocation and ultimate goals. Members of this group may also call a meeting to present these project proposal materials to management. If the appropriate decision-making managers are present at this meeting, and if sufficient information has been provided, then it is possible for these managers to make a decision whether to approve the project.

Once a new project has been approved, company management may review the project at various intervals to ensure it is being carried out as planned and provide any needed direction. Such a project review typically involves a series of loosely defined steps similar to those for initiating a project. For example, presentation materials illustrating certain project performance metrics, such as budgetary status or accomplishments to date relative to stated objectives, are often prepared by project members. A meeting is then called to present these project review materials to management. Again, as long as the appropriate decision-making managers are present at this meeting and sufficient information is presented, then it is possible for these managers to adequately review the project and provide direction for the next interval.

In addition to selecting projects and conducting project reviews, management in large companies that undertake many different projects will often want to retrieve various types of data relating to past and present projects. For example, management may want to understand what types of projects are being undertaken so that it can forecast resource needs accordingly. Management may also want to understand workforce utilization on different projects to determine whether the benefit from a particular project justifies the expense. In addition, management may want to determine the net economic effects associated with a particular project.

A number of shortcomings are associated with conventional methods for initiating a project or for providing a project review. For example, when a small business group in a relatively large company attempts to propose a project to management, it often experiences difficulty identifying the key managers necessary for project approval. As a result, these managers are often not present in the project proposal meeting. Even when the key managers are present, the information presented is often insufficient for them to decide whether to give the project the go-ahead or not. As a result, decisions on many important projects are often delayed until the key managers can be assembled or sufficient information can be pulled together.

Shortcomings are also associated with conventional methods for maintaining project data in an accessible format. For example, various business groups within large companies typically track different project metrics and maintain different types of project records. Because of these differences, it is often difficult for management to estimate workforce utilization and budgetary requirements for ongoing projects. As a result of the shortcomings associated with conventional project management, efficient and cost-effective methods and systems for project management would be desirable.

### BRIEF DESCRIPTION OF THE DRAWINGS

FIG. 1 is a flow diagram illustrating a process for initiating a project or requesting a project review in one embodiment.

FIG. 2 is a flow diagram illustrating a routine for automatically sending selected project information to a selected recipient and a selected database in one embodiment.

FIG. 3 is a diagram illustrating a project initiation display page for initiating a project in one embodiment.

FIG. 4 is a diagram illustrating a project cost display page for receiving project costs in one embodiment.

FIG. 5 is a diagram illustrating a project review display page for requesting a project review in one embodiment.

FIG. 6 is a block diagram illustrating components of a project management system in one embodiment.

FIG. 7 is a diagram illustrating contents of a project database in one embodiment.

FIG. 8 is a diagram illustrating contents of a destination database in one embodiment.

### DETAILED DESCRIPTION

Methods and systems are described for initiating a project or requesting a project review. In one embodiment, the method is implemented on a general-purpose computer, such as a personal computer, by a user who accesses a display page, such as a main project management display page, from a project management site on a server computer. From this main project management display page, the user can select a project initiation button or a project review button.

If the project initiation button is selected, then a corresponding project information display page is presented for receiving selected project information from the user. This information includes a project title, a project leader and a project category. Various project categories are possible. For example, in one embodiment, the project category could be directed toward workflow streamlining. In another embodiment, the project category could be directed toward enhancing company infrastructure or automating an existing process. In yet other embodiments, the project category could be directed toward managing product life data or developing a web-based software application that increases productivity.

After the user has entered the selected project information on the project information display page, the user can select a project cost display page for receiving cost and benefit values associated with the proposed project. For example, this project cost display page includes fields for entering cost data such as the implementation cost of the project, the ongoing operating costs of the project, the ongoing economic benefits of the project, and the net economic benefit of the project. After the user has entered the selected project cost information on the project cost display page, the user selects the send button to automatically send a portion of the information entered on both the project information display page and the project cost display page to a selected recipient, such as an appropriate decision-making manager, and to a selected database, such as a project management database, for storing the information electronically.

If the user selects the project review button on the main project management display page, then a corresponding project review display page is displayed for receiving selected information about a requested project review. The user requests the project review by entering selected project review information and selecting a send button. For example, in one embodiment, the user enters a title of the project to be reviewed, a project category, a date for the project review, and the type of project review requested. Selecting the send button after this information has been entered causes a portion of the information to be automatically sent to both a selected recipient, such as a project review scheduler, and a selected database, such as the project management database.

In one aspect of this embodiment, the selected recipients and the selected databases that automatically receive the information from the project information, project costs, and project review display pages are automatically determined based on the project category the user enters on the project information and project review display pages. As will be apparent to those of ordinary skill in the relevant art, by directly routing important project information to the necessary recipients and a selected database, the methods and systems described can be used to efficiently manage project selections and reviews. In addition, they can also provide a comprehensive and readily accessible project information database. Such a database can then be mined to determine companywide project performance statistics such as overall project expenses and overall project benefits.

As used throughout this disclosure, the phrase “project initiation” is used in reference to one or more aspects related to initiating a proposed project that may include submitting the project proposal to management for approval to proceed, allocating the resources required for project execution, and scheduling a project kickoff meeting. Similarly, throughout this disclosure the phrase “project review” is used in reference to one or more statusing events that can take place during the course of a project that may include management reviews for the purpose of determining the budgetary and schedule performance aspects of a given project relative to preset project milestones.

Certain embodiments of project management methods and systems are described in the context of computer-executable instructions performed by a general-purpose computer, such as a personal computer. For example, in one embodiment these computer-executable instructions are stored on a computer-readable medium, such as a floppy disk or CD-ROM. In other embodiments, these instructions are stored on a server computer system and accessed via a computer network such as an intranet or the Internet. Because the basic structures and functions related to computer-executable routines and corresponding computer implementation systems are well known, they have not been shown or described in detail here-to avoid unnecessarily obscuring the described embodiments.

Although the following disclosure provides specific details for a thorough understanding of several embodiments of the methods and systems described, one of ordinary skill in the relevant art will understand that these embodiments may be practiced without some of these details. In other instances, it will be appreciated that the methods and systems described can include additional details without departing from the spirit or scope of the disclosed embodiments. Although some embodiments are described in the context of initiating an engineering project or requesting an engineering project review, it will be understood that the methods and systems disclosed are usable for much broader applications and, accordingly, can be used to initiate and request reviews for projects other than those described here. In addition, it will be appreciated that the methods and systems described for concurrently sending information to a selected recipient and a selected database have utility in embodiments other than those described here. These and other embodiments will be understood by those of ordinary skill in the relevant art to fall within the scope of the present disclosure.

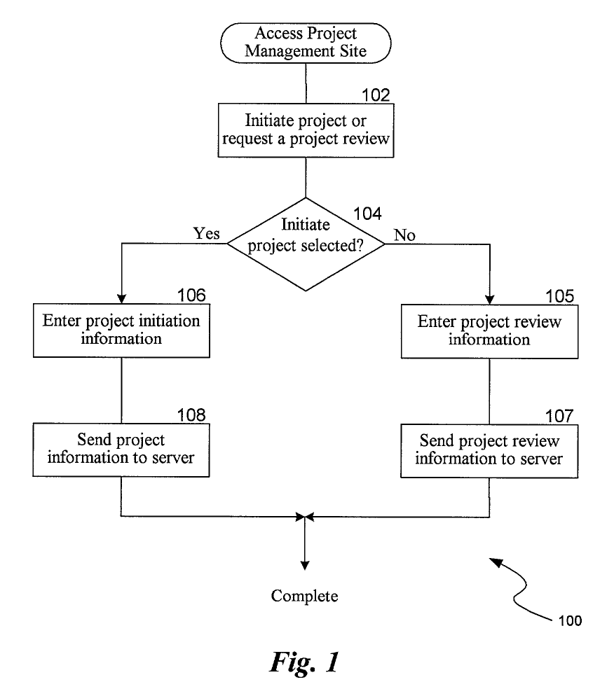

FIG. 1 is a flow diagram illustrating a process 100 for initiating a project or requesting a project review in one embodiment. The process 100 starts when a user accesses a project management site on a server computer causing a main project management display page to be presented. In block 102, the user selects either an initiate project button or a request a project review button on the main project management display page. In decision block 104, if the user selected the initiate project button, then a project initiation display page is displayed. In block 106, the user enters selected project initiation information into corresponding fields on the project initiation display page. This information can include a project title, a project leader, and a project category. In block 108, the user sends the selected project initiation information to the server computer by selecting a send button, and the project initiation portion of the process 100 is complete. As will be described in greater detail below, in one embodiment the server computer automatically sends the selected project initiation information it receives to both a selected recipient and a selected database based on the project category entered by the user in block 106.

Returning to decision block 104, if the user instead selected the project review button on the main project management display page, then a project review display page is displayed. In block 105, the user enters selected project review information into corresponding fields on the project review display page. This information can include the project title, the project category and a type of project review requested. As will be apparent to those of ordinary skill in the art, a number of different types of project reviews may take place during the life of a particular project, such as a budget, schedule or progress review. In block 107, the user sends the selected project review information to the server computer by selecting a send button, and the project review portion of the process 100 is complete. In one embodiment, as mentioned above for project initiation, upon receiving the selected project review information, the server computer automatically sends this information to both a selected recipient and a selected database based on the project category entered by the user in block 105.

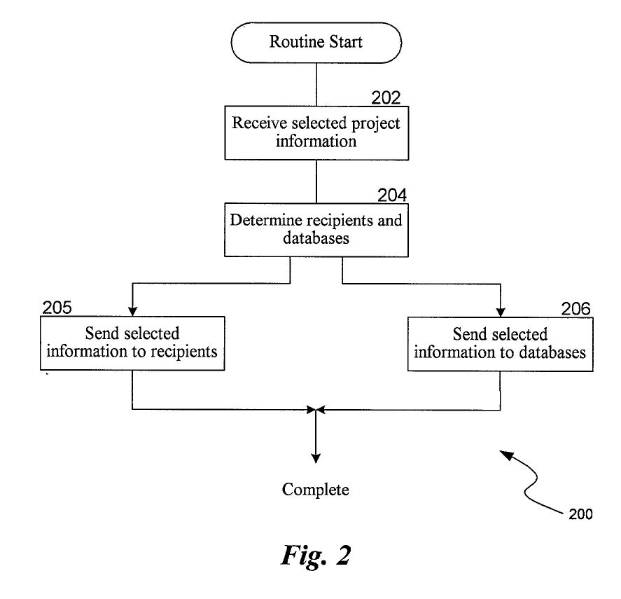

FIG. 2 is a flow diagram illustrating a routine 200 for automatically sending selected project information to a selected recipient and a selected database in one embodiment. For ease of reference, the term “project information” will be used throughout this disclosure to refer to project initiation information, project review information, or any combination or subset thereof. In one aspect of this embodiment, the routine 200 can be executed on a server computer according to computer-executable instructions contained on a computer-readable medium. In block 202, the routine receives selected project information from a remote source, such as a user computer. This information can include various details concerning a particular project, such as a category in which the project falls. In block 204, the routine determines to whom to send the selected project information (i.e., a recipient) and where to store the selected project information (i.e., a database).

In one aspect of this embodiment, the recipients and databases can be determined based on one or more project attributes. For example, the selected project information can be mapped to certain recipients and databases based on the corresponding project category. For instance, if the project category was design automation, then an individual in charge of the design automation group could, in one embodiment, be mapped to receive all information associated with design automation projects. Similarly, if the project category was infrastructure, then an infrastructure project database could, in one embodiment, be mapped to receive all information associated with infrastructure projects. In this way, all information relating to projects of a particular category is efficiently routed to recipients responsible for that category and is stored in a database corresponding to that category. In other embodiments, the recipients and databases can be determined based on other project attributes, such as the project title, the project leader, the business group responsible for the project, or the requested project start date. In block 205, the routine 200 sends, for example, by email, selected project information to the determined recipients. In block 206, the routine sends selected project information to the determined databases. After blocks 205 and 206, the routine 200 is complete.

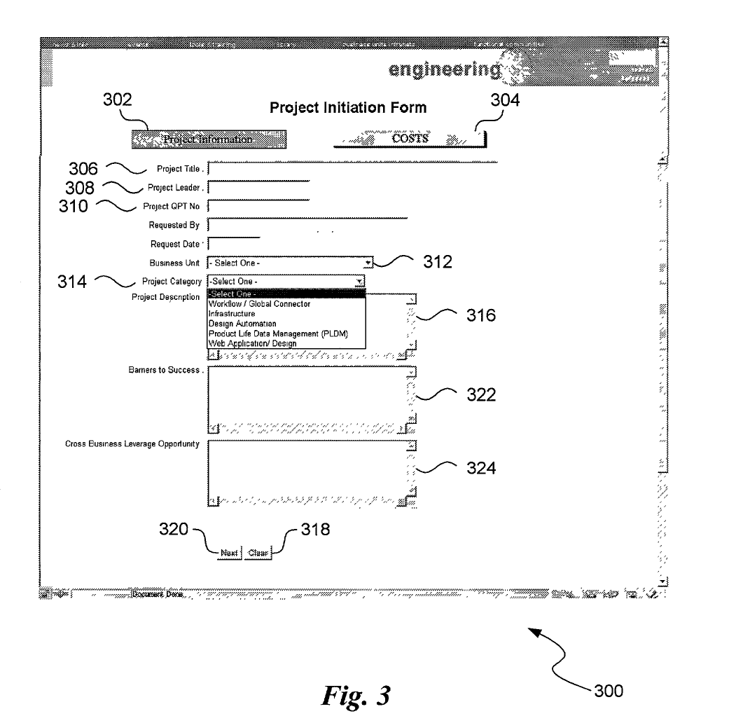

FIG. 3 is a diagram illustrating a project initiation display page 300 for initiating a project in one embodiment. In one aspect of this embodiment, the project initiation display page 300 is one of two different display pages available for entering information related to project initiation. For example, selecting a project information button on a main project management display page (not shown) results in the project initiation display page 300 being displayed as shown. Selecting a costs button 304, however, on either the project initiation display page 300 or the main project management display page, causes a project cost display page to be displayed. This project cost display page will be described in greater detail below.

The project initiation display page 300 includes a plurality of fields for entering pertinent information related to the proposed project, including a project title field 306, a project leader field 308, and a project QPT number field 310. QPT is an acronym that stands for quality project tracking. The value entered in this field uniquely identifies a specific project and is used to link the related project information to a corresponding quality project tracking database. Accordingly, the QPT number in this embodiment can be viewed as a project identifier.

The user can identify the business unit undertaking the project (e.g., Engineering, Software Design, Quality Control, etc.) by using a business unit drop-down list 312. The business units listed in the business unit drop-down list 312 may include all those within a company capable of undertaking projects, and the user simply selects the particular business unit responsible for the project being proposed. The project category is selected from a project category dropdown list 314. In one embodiment, the project categories include workflow, infrastructure, design automation, product life data management, and web application design. In this particular embodiment, the term workflow corresponds to a project aimed at streamlining existing work processes. An infrastructure project is one related to products or the hardware systems that produce or otherwise support those products. Design automation refers to a project involving the digitization of an existing manual design process. A product life data management project can be any number of different project types related to managing product life data, such as the service and repair histories of selected parts. A web application design project, as the name implies, is a project directed to one or more aspects of creating a software application for use on a computer network, such as the World Wide Web portion of the Internet. After a project category has been selected, the user can enter a project description that further defines the proposed project in a multi-line text field 316.

As will be apparent to those of ordinary skill in the relevant art, the project initiation display page 300 can include various other data input fields to suit various industry applications without departing from the spirit or scope of the present disclosure. For example, the name of the project requester can be included as well as the date the project was requested. In addition, other text fields can be provided for capturing additional project details. For example, a barriers to success field 322 can be provided for entering expected obstacles to project success. Similarly, a cross business leverage opportunity field 324 can be provided for entering possible opportunities for leveraging the benefits of the proposed project.

If at any time the user desires to revise the information entered on the project initiation display page 300, selecting a clear button 318 will accordingly clear any information entered in the above-described fields. In one aspect of this embodiment, selecting the clear button 318 causes a dialog box to be displayed giving the user an opportunity to confirm the clear request. Accordingly, the contents in the various fields will only be cleared if the user confirms the clear request. Selecting a next button 320 at any time causes a corresponding project cost display page to be displayed for receiving project cost information. Alternatively, this project cost display page can be displayed by selecting the costs button 304 as explained above.

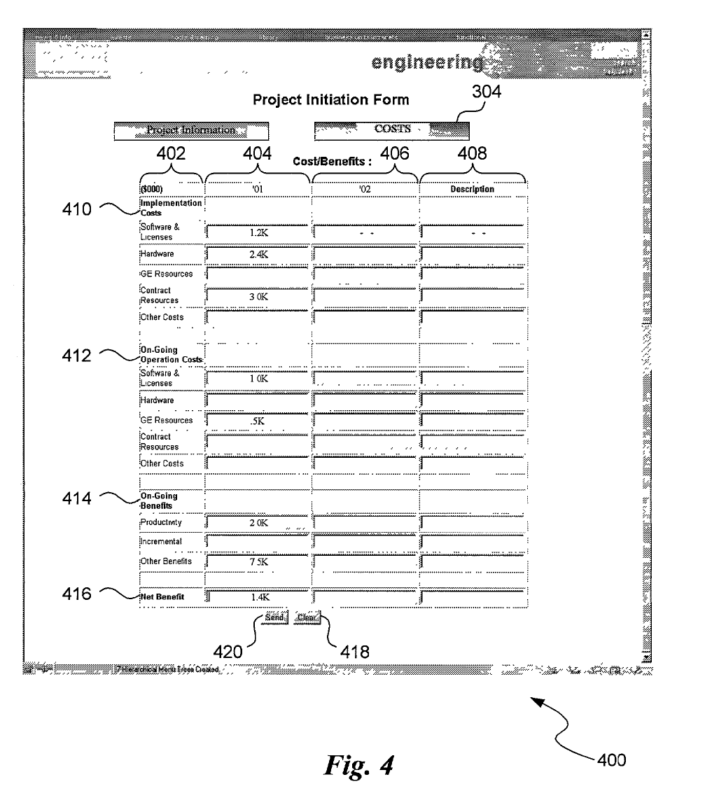

FIG. 4 is a diagram illustrating a project cost display page 400 for receiving project costs in one embodiment. The project cost display page 400 includes tables wherein the user enters various implementation costs and ongoing benefits associated with a proposed project for the current year and any out years. In the illustrated embodiment, all the input fields are numeric fields, such as dollar value fields, having two decimal places. The project cost display page 400 includes a cost identification column 402, a current-year cost column 404, one or more out-year cost columns 406, and a description column 408. The cost identification column 402 includes a plurality of rows corresponding to various implementation costs 410, ongoing operation costs 412, ongoing benefits 414, and net benefit 416.

The implementation costs 410 associated with a proposed project can include software and licenses, hardware, personnel and equipment resources, contractual resources, and other miscellaneous costs. The ongoing operation costs 412 can include cost components similar to these implementation costs. The ongoing benefits 414 associated with a proposed project can include cost reductions due to increased productivity, incremental economic benefits, and other miscellaneous economic benefits. The user completes the project cost display page 400 by entering appropriate dollar values in each cost row for each respective year of the project. The user may optionally enter a brief description of each cost and benefit in the adjacent cost description column 408.

In one aspect of the illustrated embodiment, the net benefit 416 from a proposed project is automatically calculated and displayed after the user has entered values into one or more of the corresponding cost fields. The net benefit 416 is automatically calculated by subtracting the sum of the implementation and ongoing operation costs from the total ongoing benefits. Selecting a clear button 418 at any time accordingly clears the values shown in the different fields. In one aspect of this embodiment, a dialog box is first displayed to the user giving the user an opportunity to confirm the clear request. The contents of the fields are cleared only after the user confirms the clear request.

Selecting a send button 420 after the user has completed the project cost display page 400 causes the information entered on the display pages 300 and 400 of FIGS. 3 and 4, respectively, to be automatically sent to a selected recipient and a selected database. In one aspect of this embodiment, the recipients are determined based on the project category selected by the user from the project category drop-down list 314 of FIG. 3. For example, if the user selected the workflow category, then the manager responsible for workflow projects within the company could, in one embodiment, be mapped to receive this project information because this individual would presumably have to determine whether or not this project should be undertaken. Persons responsible for monitoring company budgets, however, could be mapped to receive cost information for all project categories because, presumably, these persons will need to monitor expenditures for all types of projects. Other bases for mapping project information to recipients can be used in accordance with other embodiments.

In another embodiment, the project information entered on the display pages 300 and 400 can also be mapped to selected databases based on the project category selected by the user from the project category drop-down list 314 of FIG. 3. For example, information corresponding to workflow projects would accordingly be stored in a workflow projects database. Similarly, information corresponding to infrastructure, design automation, product life data management, and web application design projects would presumably be stored in different databases corresponding to each of these respective categories.

In another embodiment, project information can be stored in different databases according to information type. For example, cost information for all project categories could be stored in a project cost database. Similarly, information related to projects undertaken by a particular business unit could be stored in a unique database for that business. As will be apparent to those of ordinary skill in the relevant art, project information can be mapped to different databases based on any number of relevant criteria.

Organizing project information into different databases based on criteria such as project category, information type, or business unit facilitates mining of the respective databases at a later date for efficient project management at the corporate level. For example, data relating solely to infrastructure projects could be obtained by accessing only the infrastructure projects database, or, if total companywide project cost data is desired, this information could be obtained by accessing the project cost database.

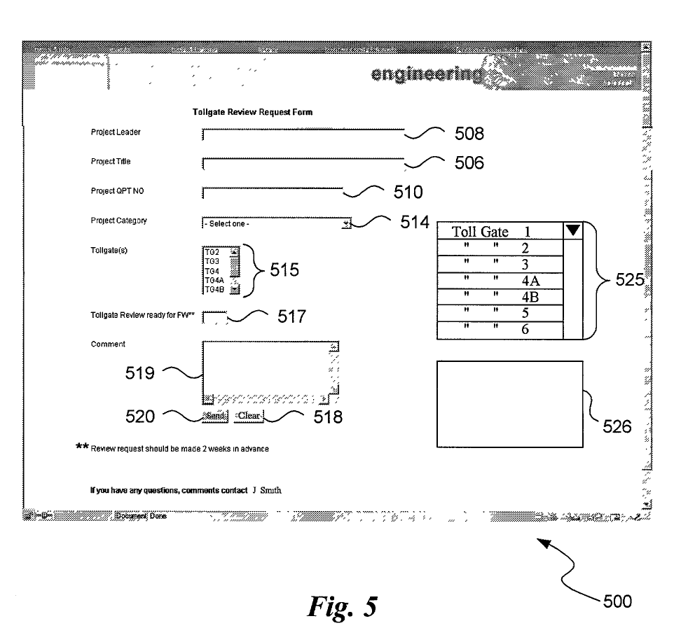

FIG. 5 is a diagram illustrating a project review display page 500 for requesting a project review in one embodiment. The project review display page 500 is used to request a review, such as a management review, of a particular project. The project review display page 500 includes a project leader field 508, a project title field 506, a project QPT number field 510, and a project category drop-down list 514. In one aspect of this embodiment, these features of the project review display page 500 are substantially similar to their corresponding counterparts included on the project initiation display page 300 of FIG. 3. The project can be identified by the QPT number that, as described above, uniquely identifies a specific project. The QPT number can be automatically generated in the QPT number field 510 based on the project information entered, or it can be manually entered by the user.

The project review display page 500 also includes a review list 515 that allows the user to select a particular type of project review. As is often the case, different types of project reviews will be appropriate at different times during the course of a given project. Similarly, different types of project reviews are often appropriate for different types of projects. Thus, the user is given the option of selecting the type of project review that best suits his or her needs in light of the type of project or the stage of the project. In one aspect of this embodiment, a project review description drop-down list 525 is provided that allows the user to obtain additional details about the types of reviews available. Selecting one of the review types in the drop-down list 525 causes details about that type of review to be displayed in an adjacent text box 526.

The project review display page 500 also includes a project review date field 517 that receives a date for scheduling the proposed project review. In one embodiment, the date field 517 is a two-digit date field that receives a two-digit number from 1-52 corresponding to a fiscal week. In other embodiments, other date configurations can be used for the date field 517 to facilitate scheduling of the proposed project review. The user can also enter comments or details about the requested project review in a text box 519. Selecting a clear button 518 allows the user to reset the data entered in the respective fields.

Once the user has entered sufficient information on the project review display page 500, selecting a send button 520 causes the information to be automatically sent to a selected recipient and a selected database. Much like the display pages 300 and 400 described above, in one embodiment the recipients and databases that receive the project review information are determined based on the project category selected by the user from the drop-down list 514. In other embodiments, the recipients and databases can be determined based on other criteria. For example, in another embodiment the project review information can be automatically sent to recipients and databases based on the type of review requested, or based on the business unit requesting or conducting the review.

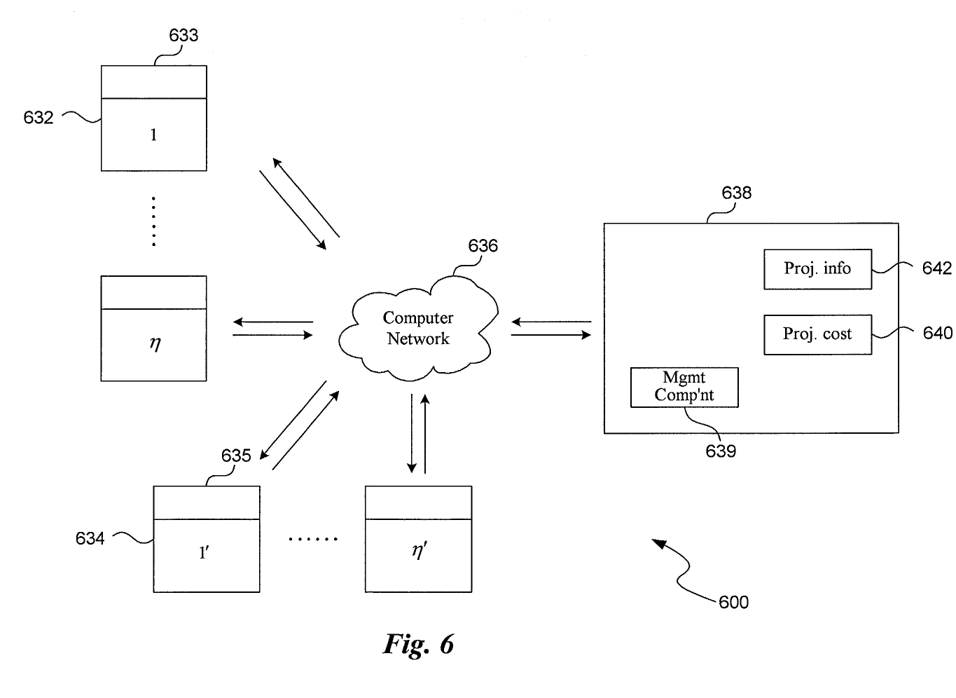

FIG. 6 is a block diagram illustrating components of a project management system 600 in one embodiment. User computers 632 are connected to a server computer 638 via a computer network 636. In one aspect of this embodiment, the computer network 636 can be a local area network (LAN), such as an intranet, or the Internet. The user computers 632 may include a central processing unit, memory devices, input devices (e.g., keyboard and pointing device), output devices (e.g., display devices), and storage devices (e.g., disc drives). The memory and storage devices are computer-readable media that may contain computer instructions for implementing methods and systems, such as routines and display pages, in accordance with this disclosure. The user computers 632 may also include a browser module 633 that allows the user to access and exchange data with the computer network 636, including web sites within the World Wide Web portion of the Internet. In one aspect of this embodiment, the user computers 632 may be operated by various users, such as project initiators or project review requesters.

In one embodiment, the server computer 638 includes a project management component 639, a project information database 642, and a project cost database 640. The project management component 639 receives project initiation and project review request information, determines appropriate recipients and databases for the received information, and provides the received information to the appropriate recipients and databases. For example, in one embodiment the project management component 639 provides general project information to the project information database 642 and project cost information to the project cost database 640. The project management system 600 also includes one or more user computers 634, such as recipient computers, for receiving project initiation and project review request information sent, such as by email, from the server computer 638. In one aspect of this embodiment, the recipient user computers 634 can be substantially similar in both structure and function to the initiator/requestor user computers 632 described above, and accordingly they can include a browser module 635.

The project management component 639 of the server computer 638 can also receive project data requests from the various user computers 632 and 634. When this occurs, the project management component 639 accesses an associated database, such as the project information database 642 or the project cost database 640, and retrieves the requested project data and sends it to the requesting user computer. The requested information may also be formatted into an associated display description, such as a display page, for sending to the requesting user computer for display. As will be apparent to those of ordinary skill in the relevant art, the server computer 638 may contain additional databases for capturing or organizing other relevant project data in configurations different from those described here without departing from the present disclosure.

One skilled in the relevant art will appreciate that concepts of the project management system 600 can be implemented in various environments other than the intranet or the Internet as described above. For example, these concepts may also be implemented in an electronic mail, or “email,” environment in which the email messages include the equivalent of a display page and associated project information. Accordingly, project information can be requested and received from the server computer 638 using electronic messages. Also, various communication channels other than the Internet may be used, such as a wide area network or a point-to-point dial-up connection. The concepts of the project management system 600 may also be used in a single computer environment rather than the client/server environment illustrated in FIG. 6. Consistent with these variations, the server computer 638 may comprise any combination of hardware or software that can support these concepts. In particular, the server computer 638 may actually include multiple computers. Similarly, the user computers 632 may include television-based systems and various other computational devices through which web pages and other display descriptions may be accessed.

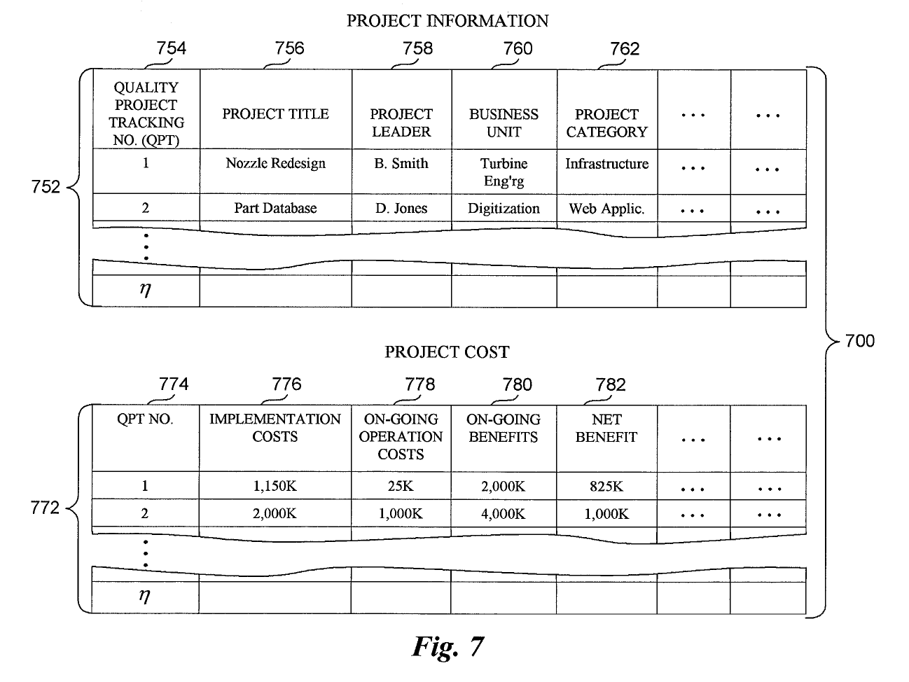

FIG. 7 is a diagram illustrating contents of a project database 700 in one embodiment. The project database 700 includes a project information table 752 and a project cost table 772. Each entry in the project information table 752 can include a project identifier 754 and a project title 756. In one embodiment, the project identifier 754 is the QPT number. As discussed above, the QPT number is uniquely associated with a specific project and is used to link that project to related databases. The project information table 752 can include other contents such as a project leader 758, a business unit 760 and a project category 762. As described above, the business unit in this embodiment is the particular group within a company responsible for carrying out the project. As was also described above, the project category (e.g., work flow, infrastructure, design automation, etc.) can be used to determine the recipients and databases that will receive the selected information. In the illustrated embodiment of FIG. 7, the project cost table 772 includes a project identifier 774, such as the QPT number, and various other cost information. This information can include implementation costs 776, ongoing operation costs 778, ongoing benefits 780, and net benefit 782. As will be apparent to those of ordinary skill in the relevant art, capturing and organizing pertinent project information into data tables, such as the project information table 752 and the project cost table 772, can facilitate search queries for retrieving useful information, such as accurate budgetary and workforce utilization assessments.

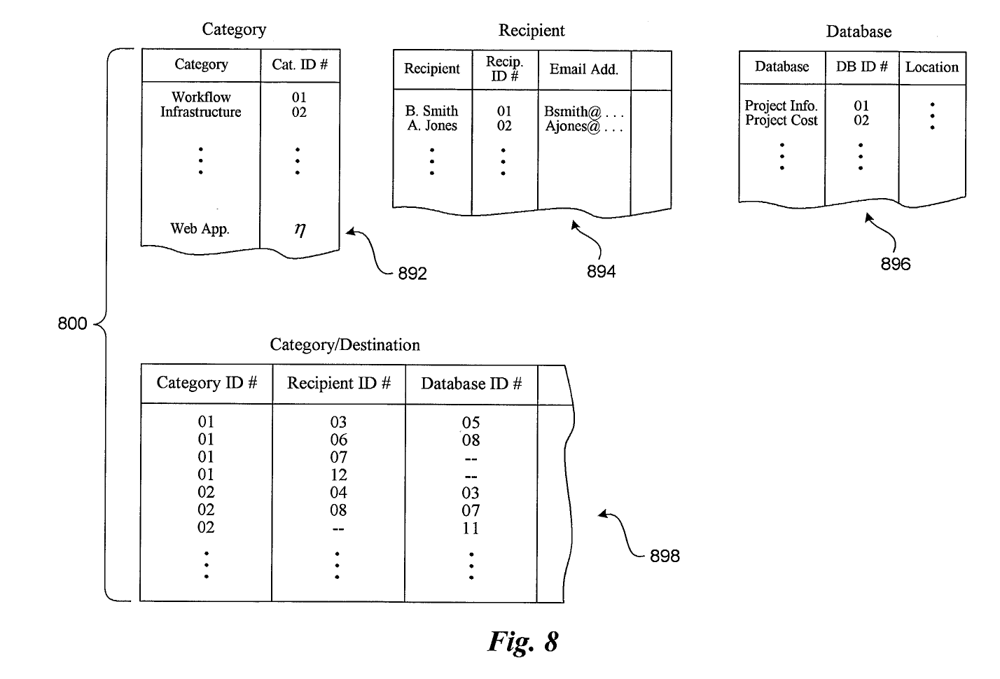

FIG. 8 is a diagram illustrating contents of a destination database 800 in one embodiment. The destination database 800 can be used in one embodiment to map project categories with destinations, such as recipients or databases. The destination database 800 includes a category table 892, a recipient table 894, a database table 896 and a category/destination table 898. The category table 892 associates each category with a category identifier, such as a two digit number. The recipient table 894 associates individual recipients, such as management personnel, with an identifier and an address, such as an email address. Similarly, the database table 896 associates databases for storing project information with an identifier and an address, such as a file location. The category/destination table 898 then associates each category identifier with one or more recipient identifiers and one or more database identifiers. Accordingly, the category/destination table 898 can be used to direct project information associated with a particular project category to one or more recipients and/or one or more databases.

It will be appreciated from the foregoing that, although specific embodiments of the project management system have been described above for purposes of illustration, various modifications may be made without deviating from the spirit or scope of the invention. For example, in other embodiments, other types of project information can be provided in addition to, or in place of, the selected types described above. Similarly, other criteria can be used to determine the recipients and the databases that receive the project information. The particular types of project initiation information and project review information that are stored in the databases can also vary from those described above and yet still accord with the present disclosure.

Further, although the methods and systems have been described in the context of engineering project management, it will be apparent that the methods and systems are equally well suited to management of other types of projects typically engaged in by other types of companies. Those of ordinary skill in the relevant art will appreciate that these and other changes can be made to the invention in light of the above-detailed description.

While certain aspects of the invention are presented below in certain claim forms, the inventors contemplate the various aspects of the invention in numerous different claim forms. Accordingly, the inventors reserve the right to add additional claims after filing the application to pursue such additional claim forms for all aspects of the invention. Further, the terms used in the following claims should not be construed to limit the invention to the specific embodiments disclosed in the specification or the claims, but should be construed to include all project management systems that operate in accordance with the claims to facilitate project initiation or project review requests. The invention is therefore not limited by this disclosure, but instead, the scope of the invention is to be determined entirely by the following claims.

1. a method in a computer system for managing a project, the method comprising:
receiving a first request for a project management display page;
in response to receiving the first request, providing the project management display page, the project management display page being configured to receive a selection for a project initiation display page or a project review display page;
receiving a second request for the project initiation display page or the project review display page;
when the received second request is for the project initiation display page, in response to receiving the second request, providing the project initiation display page, the project initiation display page being configured to receive selected project initiation information including a first project attribute;
receiving the selected project initiation information; and
in response to receiving the selected project initiation information, automatically sending a portion of the received selected project initiation information to a selected first recipient and a selected first database based on the first project attribute; and
when the received second request is for the project review display page, in response to receiving the second request, providing the project review display page, the project review display page being configured to receive selected project review information including a second project attribute;
receiving the selected project review information; and
in response to receiving the selected project review information, automatically sending a portion of the received selected project review information to a selected second recipient and a selected second database based on the second project attribute.

2. The method of claim 1 wherein the first and second project attributes are project categories.

3. The method of claim 1 wherein the project initiation display page includes:
a project category drop-down list for selecting a project category, the project category drop-down list comprising one or more of:
a workflow project;
an infrastructure project;
a design automation project;
a product life data management project; and
a web application project.

4. The method of claim 1 wherein the project initiation display page includes:
a barriers to success field for identifying possible obstacles to project success; and
a business leverage opportunity field for identifying opportunities for leveraging the project.

5. The method of claim 1 wherein the selected project initiation information further comprises project cost information.

6. The method of claim 1 wherein the selected project initiation information further comprises project cost information including a project implementation cost.

7. The method of claim 1 wherein the selected project review information further comprises a type of project review requested.

8. A method in a computer system for providing project information to one or more selected destinations, the method comprising:
providing a project display page to a user, the project display page being configured to receive selected project information from the user;
receiving the selected project information;
in response to receiving the selected project information, selecting a destination based on the received selected project information; and
automatically sending a portion of the received selected project information to the selected destination.

9. The method of claim 8 wherein:
the selected project information comprises a project category selected by the user; and
the selected destination is selected based on the project category selected by the user.

10. The method of claim 8 wherein:
the selected project information comprises project cost information entered by the user; and
the portion of the received selected project information automatically sent to the selected destination includes the project cost information.

11. The method of claim 8 wherein:
the selected project information comprises a type of project review requested; and
the portion of the received selected project information automatically sent to the selected destination includes the type of project review requested.

12. The method of claim 8 wherein the project display page comprises one or more of:
a project category field for receiving a category for the project;
a project cost field for receiving a cost for the project; and
a project review type field for receiving a type of review for the project.

13. The method of claim 8 wherein the selected destination is a recipient.

14. The method of claim 8 wherein the selected destination is a database.

15. The method of claim 8 wherein the selected destination is a selected recipient, the method further comprising:
in response to receiving the selected project information, selecting a database based on the received selected project information; and
automatically sending a portion of the received selected project information to the selected database.

16. A method for managing a project, the method comprising:
receiving a request to initiate a project or conduct a project review;
when the received request is to initiate a project, in response to the received request, providing a project initiation page configured to receive selected project initiation information including a first project attribute;
receiving the selected project initiation information; and
in response to receiving the selected project initiation information, sending a portion of the received selected project initiation information to a selected first recipient and a selected first database based on the first project attribute; and
when the received request is to conduct a project review, in response to the received request, providing a project review page configured to receive selected project review information including a second project attribute;
receiving the selected project review information; and
in response to receiving the selected project review information, sending a portion of the received selected project review information to a selected second recipient and a selected second database based on the second project attribute.

17. The method of claim 16 wherein the first and second project attributes are project categories.

18. The method of claim 16 wherein:
the first and second project attributes are project categories, the project categories comprising one or more of:
a workflow project;
an infrastructure project;
a design automation project;
a product life data management project; and
a web application project.

19. The method of claim 16 wherein:
the selected project review information further comprises a type of project review requested; and
the portion of the received selected project review information sent to the selected second recipient and the selected second database includes the type of project review requested.

20. The method of claim 16 wherein:
the selected project initiation information further comprises project cost information; and
the portion of the received selected project initiation information sent to the selected first recipient and the selected first database includes the project cost information.

21. A computer-readable medium containing a display page for initiating a project, the display page comprising:
a project identifier field for receiving an identifier associated with the project;
a business unit field for receiving a business unit associated with implementing the project;
a project category field for receiving a category associated with the project; and
a project description field for receiving one or more details about the project.

22. The computer-readable medium of claim 21 wherein the display page further comprises a project cost field for receiving a cost associated with the project.

23. The computer-readable medium of claim 21 wherein the display page further comprises one or more of:
a barriers to success field for receiving one or more factors that could adversely affect the project; and
a business leverage field for receiving one or more opportunities for leveraging the project.

24. The computer-readable medium of claim 21 wherein the display page further comprises:
a project category drop-down list for selecting a project category for the project category field, the project category drop-down list including one or more of:
a workflow project;
an infrastructure project;
a design automation project;
a product life data management project; and
a web application project.

25. A computer-readable medium containing a display page for presenting costs and benefits associated with a project, the display page comprising:
one or more project implementation cost fields;
one or more ongoing project operation cost fields;
one or more ongoing benefits fields; and
a net benefit field.

26. The computer-readable medium of claim 25 wherein:
the one or more project implementation cost fields are first project implementation cost fields;
the one or more ongoing project operation cost fields are first ongoing project operation cost fields;
the one or more ongoing benefits fields are first ongoing benefits fields; and
the net benefit field is a first net benefit field, wherein the first project implementation cost fields, the first ongoing project operation cost fields, the first ongoing benefits fields, and the first net benefit field are arranged in a first column corresponding to a current year, and wherein the display page further comprises:
one or more second project implementation cost fields;
one or more second ongoing project operation cost fields;
one or more second ongoing benefits fields; and
a second net benefit field, wherein the second project implementation cost fields, the second ongoing project operation cost fields, the second ongoing benefits fields, and the second net benefit field are arranged in a second column corresponding to an out year.

27. The computer-readable medium of claim 25 wherein:
the one or more project implementation cost fields include:
a first software cost field; and
a first hardware cost field;
the one or more ongoing project operation cost fields include:
a second software cost field; and
a second hardware cost field; and
the one or more ongoing benefits fields include:
a productivity benefit.

28. The computer-readable medium of claim 25 wherein:
the one or more project implementation cost fields receive one or more implementation cost values;
the one or more ongoing project operation cost fields receive one or more ongoing operation cost values;
the one or more ongoing benefits fields receive one or more ongoing benefit values; and
the net benefit field receives a net benefit value based on the received implementation cost values, the received ongoing operation cost values, and the received ongoing benefit values.

29. The computer-readable medium of claim 25 wherein:
the one or more project implementation cost fields receive one or more implementation cost values;
the one or more ongoing project operation cost fields receive one or more ongoing operation cost values;
the one or more ongoing benefits fields receive one or more ongoing benefit values; and
the net benefit field receives a net benefit value that is at least approximately equal to the difference between the sum of the received ongoing benefit values and the sum of the received implementation cost values and the received ongoing operation cost values.

30. A computer-readable medium containing a display page for requesting a project review, the display page comprising:
a project identifier field for receiving an identifier associated with the project;
a project category field for receiving a category associated with the project; and
a project review type field for receiving a type of project review.

31. The computer-readable medium of claim 30 wherein the display page further comprises:
a project review date field for receiving a schedule date for the project review; and
a project review description field for receiving one or more details related to the project review.

32. The computer-readable medium of claim 30 wherein the display page further comprises:
a project category drop-down list for selecting a project category for the project category field, the project category drop-down list including one or more of:
a workflow project;
an infrastructure project;
a design automation project;
a product life data management project; and
a web application project.

33. The computer-readable medium of claim 30 wherein the display page further comprises a project review type description field for providing a description of a type of project review.

34. A computer system for managing a project, the computer system comprising:
means for receiving a request for a project management display page;
means for providing the project management display page in response to the received request, the project management display page being configured to receive a selection for a project initiation display page or a project review display page;
means for receiving the selection for the project initiation display page or the project review display page;
when the received selection is for the project initiation display page, means for providing the project initiation display page in response to the received selection, the project initiation display page being configured to receive selected project initiation information including a first project attribute;
means for receiving the selected project initiation information; and
in response to receiving the selected project initiation information, means for automatically sending the selected project initiation information to a selected first recipient and a selected first database based on the first project attribute; and
when the received selection is for the project review display page, means for providing the project review display page in response to the received selection, the project review display page being configured to receive selected project review information including a second project attribute;
means for receiving the selected project review information; and
in response to receiving the selected project review information, means for automatically sending the selected project review information to a selected second recipient and a selected second database based on the second project attribute.

35. The computer system of claim 34 wherein the project initiation display page includes:
a project category drop-down list for selecting a project category, the project category drop-down list comprising one or more of:
a workflow project;
an infrastructure project;
a design automation project;
a product life data management project; and
a web application project.

36. The computer system of claim 34 wherein the selected project review information further comprises a type of project review requested.

37. The computer system of claim 34 wherein the selected project initiation information further comprises project cost information.

38. A computer system for providing project information to a selected recipient and a selected database, the computer system comprising:
means for providing a project display page to a user, the project display page being configured to receive selected project information from the user;
means for receiving the selected project information;
in response to receiving the selected project information, means for selecting a recipient based on the received selected project information;
in response to receiving the selected project information, means for selecting a database based on the received selected project information; and
means for automatically sending a portion of the received selected project information to the selected recipient and the selected database.

39. The computer system of claim 38 wherein:
the selected project information comprises a project category selected by the user; and
the selected recipient and the selected database are selected based on the selected project category.

40. The computer system of claim 38 wherein:
the selected project information comprises a project cost entered by the user; and
the portion of the received selected project information automatically sent to the selected recipient and the selected database includes the project cost.

41. The computer system of claim 38 wherein:
the selected project information comprises a type of project review; and
the portion of the received selected project information automatically sent to the selected recipient and the selected database includes the type of project review.

42. The computer system of claim 38 wherein the project display page comprises one or more of:
a project category field; and
a project review type field.

43. A computer-readable medium whose contents cause a computer system to provide project information to one or more of a selected recipient or a selected database, the information being provided by a method comprising:
receiving a request for a project display page;
providing the project display page, the project display page configured to receive selected project information;
receiving the selected project information;
in response to receiving the selected project information, selecting one or more of a recipient or a database based on the received selected project information; and
automatically sending a portion of the received selected project information to one or more of the selected recipient or the selected database.

44. The computer-readable medium of claim 43 wherein:
the selected project information comprises a project category; and
the selected recipient and the selected database are selected based on the selected project category.

45. The computer-readable medium of claim 43 wherein:
the selected project information comprises project cost information; and
the portion of the received selected project information automatically sent to one or more of the selected recipient or the selected database includes the project cost information.

46. The computer-readable medium of claim 43 wherein:
the selected project information comprises a type of project review requested; and
the portion of the received selected project information automatically sent to one or more of the selected recipient or the selected database includes the type of project review requested.

47. A computer memory containing a project database, the project database comprising:
a project information table comprising a plurality of entries, each entry comprising:
a project identifier that identifies a project; and
a project category associated with the identified project; and
a project cost table comprising a plurality of entries, each entry comprising:
the project identifier; and
a project cost associated with the identified project.

48. The computer memory of claim 47 wherein each entry in the project information table further comprises:
a project leader, the project leader being associated with management of the identified project; and
a business unit, the business unit being associated with implementation of the identified project.

49. The computer memory of claim 47 wherein each entry in the project cost table further comprises:
an implementation cost associated with the identified project;
an ongoing operation cost associated with the identified project;
an ongoing benefit associated with the identified project; and
a net benefit associated with the identified project.

50. A method in a computer system for initiating a project, the method consisting essentially of:
displaying a project initiation display page;
entering information associated with the project on the project initiation display page; and
automatically sending a portion of the entered information to one or more selected recipients or one or more selected databases by selecting a send button on the project initiation display page.

51. The method of claim 50 wherein:
the entered information includes a selected project category, and
the portion of the entered information is automatically sent to the one or more selected recipients and the one or more selected databases based on the selected project category.

52. The method of claim 50 wherein:
the project initiation display page includes a project category drop-down list for selecting a project category; and
the project category drop-down list comprises one or more of:
a workflow project;
an infrastructure project;
a design automation project;
a product life data management project; and
a web application project.

53. A method in a computer system for requesting a project review, the method consisting essentially of:
displaying a project review display page;
entering information associated with the project review on the project review display page; and
automatically sending a portion of the entered information to one or more selected recipients and one or more selected databases by selecting a send button on the project review display page.

54. The method of claim 53 wherein:
the entered information includes a selected project category, and
the portion of the entered information is automatically sent to the one or more selected recipients and the one or more selected databases based on the selected project category.

55. The method of claim 53 wherein the entered information includes a type of project review requested.
